(19) United States
(12) Patent Application Publication
(10) Pub. No.: US 2025/0179990 A1
(43) Pub. Date: Jun. 5, 2025

(54) OFFSHORE WIND TURBINE FOR FRESHWATER PRODUCTION, WIND FARM AND METHOD FOR PRODUCING FRESHWATER

(71) Applicant: Siemens Gamesa Renewable Energy A/S, Brande (DK)

(72) Inventors: Per Egedal, Herning (DK); Benedikt Mayerle, Lüneburg (DE); Johnny Soerensen, Videbaek (DK)

(21) Appl. No.: 18/834,481

(22) PCT Filed: Jan. 12, 2023
(86) PCT No.: PCT/EP2023/050616

§ 371 Date: Jul. 30, 2024

(30) Foreign Application Priority Data
Feb. 7, 2022 (EP) 22155322.5

(51) Int. Cl. F03D 13/25; F03D 9/20

(52) U.S. Cl. CPC F03D 13/25; F03D 9/20; F05B 2220/62; F05B 2240/95

(57) ABSTRACT

An offshore wind turbine is provided, including a foundation carrying a tower, the tower carrying a nacelle, wherein a generator for generating electrical power is housed in the nacelle, and a rotor including wind turbine blades, which is mounted to a rotor hub and coupled to the generator for providing mechanical input power to the generator, wherein the wind turbine further includes at least one desalination plant mounted at an installation position of the wind turbine, the installation position including
an installation support mechanically supporting the desalination plant,
a power interface for providing electrical power from the generator to the desalination plant,
a seawater interface for providing seawater from the installation site of the wind turbine to the desalination plant, and
a freshwater interface for feeding freshwater produced by the desalination plant into a freshwater piping infrastructure for transporting the freshwater to an onshore, freshwater receiving site.

### CROSS-REFERENCE TO RELATED APPLICATIONS

This application is a national stage of PCT Application No. PCT/EP2023/050616, having a filing date of Jan. 12, 2023, claiming priority to EP Application Serial No. 22155322.5, having a filing date of Feb. 7, 2022, the entire both contents of which are hereby incorporated by reference.

### FIELD OF TECHNOLOGY

The following relates to an offshore wind turbine, comprising a foundation carrying a tower, the tower carrying a nacelle, wherein a generator for generating electrical power is housed in the nacelle, and a rotor comprising wind turbine blades, which is mounted to a rotor hub and coupled to the generator for providing mechanical input power to the generator. The invention further concerns a wind farm and a method for producing freshwater.

### BACKGROUND

Wind turbines for the generation of electrical power are well-known in the state of the art and typically comprise a tower and a nacelle mounted on the tower. A rotor hub is fixed to the nacelle, to which a rotor of the wind turbine is rotatably mounted. The rotor usually comprises multiple wind turbine blades. Since the rotor is coupled to a generator in the nacelle, the rotational mechanical power (wind power) can be converted to electrical power by the generator. Since, usually, AC power of different frequencies is output by the generator, an AC-DC converter, which may also be located in the nacelle, is used to convert the AC electrical power to DC electrical power. To supply the electrical power generated in the wind turbine to a power grid, additional DC-AC conversion devices are usually employed such that the electrical power satisfies grid code requirements.

Wind turbines are placed where high amounts of mechanical energy (wind) may be harvested, in particular at offshore locations on the sea. Such turbines may also be called offshore wind turbines and usually comprise a foundation at the installation site, wherein such a foundation may be floating or fixed, for example mounted on or in the seabed.

On the other hand, freshwater, in particular clean drinking water, is becoming a scarce resource in some areas, in particular where water drilling is not available as an option. While freshwater is an important resource in everyday life of human beings, it is also required for many industrial applications, be it emerging or conventional economies. Reasons for the scarcity of water comprise, for example, changes in land use and unsustainable water consumption. Hence, new technologies for water desalination have been proposed, in particular regarding industrial scale applications. The research aims at decreasing specific energy need for the production of freshwater (desalinated water). However, access to cheap and clean feedstock (salt water and energy) is a key for a sustainable development.

An exemplary technology to desalinate water are reverse osmosis plants, wherein the process of osmosis is reversed by using a pump to pressurize saltwater through a partially permeable membrane to separate ions, unwanted molecules and larger particles from the water. The pressure is chosen to overcome osmotic pressure. Here, it has been proposed to use large onshore installations of reverse osmosis plants to purify seawater into freshwater, in particular drinking water. The energy needed for the process in these, or comparable solutions is usually supplied by an electrical power grid.

To provide so-called “green” solutions, it was proposed to use so-called “green” electricity, in particular from renewable sources for reverse osmosis or other desalination approaches. Examples are photovoltaics or the already mentioned wind power.

To use offshore wind power in an onshore desalination plant, the electrical power has to be transmitted to an onshore location by a power grid, which may also be called transmission grid. In embodiments, the transmission grid may connect an offshore wind farm to an onshore transformer station of an onshore electrical power grid, where the electricity is transformed to a voltage compatible with the onshore electrical power grid.

However, offshore wind farms are often remote from the shore, such that a large distance between the offshore wind farm and the onshore location, to which the electrical power is to be transmitted, has to be bridged. Hence, long power lines having very high installation costs are required and high losses may occur.

In articles by Antonio Jarquin-Laguna and Francesca Greco, “Integration of Hydraulic Wind Turbines for Seawater Reverse Osmosis Desalination”, Conference Paper, July 2019 (DOI: 10.1109/OSES.2019.8867343), and by Roy Smits et al., “Analysis of a Wind Driven Reverse Osmosis Desalination System”, Delft University of Technology, Apr. 17, 2019, it was proposed to use hydraulic wind turbines to drive reverse osmosis. However, such constructions require a complex, dedicated hydraulic power conversion and transmission system still to be researched.

DE 202 06 234 U1 discloses a floating wind power plant comprising a buoyancy body having on opposite sides a rotor unit and an underwater part, wherein the rotor unit comprises at least one Gelhard rotor. The floating wind power plant can use anchors to be bound to a working position. During operation, a rotating body in the underwater part is rotated by the Gelhard rotor, storing kinetic energy and thus buffering changes in available wind energy. The rotating body acts as a multi-pole generator which generates electrical energy. In the area of the buoyancy body, a saltwater desalination plant can be positioned, which is powered by a fuel cell using hydrogen produced by electrolysis of water, which, in turn, is powered by the electrical energy of the multi-pole generator.

US 2002/0182946 A1 discloses a power generation plant ship having a body with a propulsion mechanism and including a solar power generation system, a wind power generation system for obtaining electric energy by driving a generator by rotating a windmill by receiving wind power, and a storage battery for storing the electric energy generated by the respective power generation systems. The power generation plant ship can sail on the sea, so that the ship can move to a place where the sunlight can be most effectively received and a place where the wind power is strong enough for generating power. The power generation plant may also comprise a seawater freshening system for freshening seawater to obtain fresh water, which is used in an electrolysis system for electrolyzing the fresh water to obtain hydrogen and oxygen, which may be stored, used by a fuel cell or be transmitted to a land base.

DE 201 17 211 U1 discloses a salt water or freshwater wave power plant, wherein the waves are used to pump water into a tank, from where it rotates a turbine to convert the potential energy into electrical energy. The wave power plant can, for example, be anchored to the seafloor using a steel construction. The wave power plant is understood as a “house”, wherein it is proposed to additionally use a wind power plant on “the roof of the house”. The wind power plant does not have its own generator. The wave power plant can be used to prepare fresh water which can be pumped into a desert.

DE 10 2007 029 921 B3 discloses a device for producing energy and fresh water in the sea. This device is a half-underwater, rotatably anchored island, which carries a large surface on which photovoltaic modules and wind converters are placed. Inside the hollow body providing the surface, aggregates, energy storages as well as electrical power lines and water lines are provided. In this manner, the island can even travel long distances, such that it is a combination of island and ship.

### SUMMARY

An aspect of embodiments of the invention provides a system and method for desalination of seawater which has a low complexity, is cheap to implement and uses renewable energy with less losses.

According to embodiments of the invention, an offshore wind turbine as initially described further comprises at least one desalination plant mounted at an installation position of the wind turbine, wherein the installation position comprises
an installation support mechanically supporting the desalination plant,
a power interface for providing electrical power from the generator to the desalination plant,
a seawater interface for providing seawater from the installation site of the wind turbine to the desalination plant, and
a freshwater interface for feeding freshwater produced by the desalination plant into a freshwater piping infrastructure for transporting the freshwater to a, in particular onshore, freshwater receiving site.

As known in the art, the foundation may be either fixed or floating. The installation position may be provided at the foundation or the tower, in particular on a component fixed to the foundation and/or the tower. Here, the tower and/or the foundation may also comprise at least one transition piece.

An embodiment of the invention proposes to integrate water desalination into an offshore wind turbine, bringing together two technologies and enabling the production of freshwater from wind energy while bringing about additional advantages. Due to its offshore position, an optimal location regarding the resources, namely seawater from the sea and wind energy at sea, is chosen to produce freshwater, which can be transported easily and cheaply using a respective freshwater piping infrastructure, in particular pipelines or other logistical solutions. Due to the high level of integration, losses and costs compared to an onshore desalination plant driven by renewable energy are reduced. As also discussed below, since the desalination plant can be operated using an electrical direct current (DC electrical power), in addition to complicated electrical energy transmission over a power grid, in particular a transmission grid, energy conversion steps may be omitted. The efficiency can be increased, in particular by more than 9%.

The wind turbine discussed here is an off-grid offshore wind turbine. “Off-grid” describes a wind turbine which is not connected to a power grid such that generated electrical power can be supplied to the power grid, in particular according to a standard grid code and involving switch gear and the like. It is, however, noted that in embodiments, the off-grid offshore wind turbine may be connected to a power grid for receiving power to power auxiliary systems and ancillary components necessary for operation of the wind turbine, for example in cases where the wind turbine is unable to generate electric power for maintaining its basis operation. The wind turbine according to embodiments of the invention relieves energy distribution grids and grid code requirements can be neglected.

In embodiments of the invention, renewable electrical energy provided as an electrical direct current (DC) can be utilized directly without any requirements to convert to alternating current (AC). Several components are saved, reducing investment costs as well as operation and maintenance costs. Generally, operation will be simplified. Furthermore, fees for a power grid, electricity devices, levies and taxes are also saved for electricity consumption.

In summary, embodiments of the invention allows to utilize very remote areas, that is, the open sea, to generate renewable energy and use it for water desalination, where cost for transporting electrical energy to onshore locations has been too expensive.

In an embodiment, the interfaces provided are standardized interfaces matching standardized interfaces of the desalination plant for power, seawater intake and freshwater outlet. For example, conventional DC power plugs and/or pipe connectors/couplings may be used.

In an embodiment, the desalination plant may be a reverse osmosis plant, where the electrical power is used at least to drive a reverse osmosis pump of the reverse osmosis plant. Reverse osmosis plants (RO plants) are often used to desalinate water and usually comprise a DC driven reverse osmosis pump, which can be operated using the electrical power generated by the wind turbine. Furthermore, and also generally, the desalination plant may, of course, comprise ancillary electrical consumers, for example control components and the like, which may also be operated using the electrical power generated by the wind turbine.

In embodiments, the desalination plant further comprises at least one pressure reservoir for providing pressure for reverse osmosis when electrical power from the generator is not available. In an embodiment, such a pressure reservoir may comprise a high-pressure storage tank. If, for example, not enough wind is available, the wind turbine may not be able to provide electrical power for operating the reverse osmosis pump. In such cases, a pressure reservoir, in particular a high-pressure storage tank using liquid and/or gas, may be used as a temporary replacement for the reverse osmosis pump. Hence, freshwater production can be kept up. In other words, the pressure reservoir buffers intermittent wind energy.

In embodiments, the desalination plant may be containerized and/or comprise standardized respective interfaces to connect to the interfaces at the installation position. The desalination plant may comprise outer dimensions of a conventional shipping container (intermodal container), for example according to the ISO 830 standard. The container of the desalination plant, which receives other components of the desalination plant, also serves as an outer housing for the desalination plant. Since the desalination plant is constantly exposed to an open atmosphere containing salt, which greatly accelerates the corrosion, the container serves a protection function, in particular protecting the reverse osmosis system. Since the outer dimensions of the container conform to a standard, in particular the ISO 830 standard, the desalination plant can be easily transported to and from the wind turbine employing respective standardized transportation methods, in particular sea vessels. It is noted that such containerized desalination plants, in particular reverse osmosis plants, have already been proposed for other applications, for example naval applications on ships. Hence, available components may be used, wherein the interfaces at the installation position respectively match the standards used for the containerized desalination plant. If a containerized desalination plant is used, furthermore, the installation position may also comprise fastening means suitable to cooperate with fastening the container.

As already discussed, the wind turbine may further comprise at least one AC-DC converter for converting AC power from the generator into DC power. In this manner, the varying frequencies of the alternating current provided dependent on rotation speeds/wind velocities may be converted into direct current of in particular constant voltage, which, according to embodiments of the invention, may directly be used to operate the desalination plant. Further, large converters to convert all of the DC electrical power into AC power to be introduced into a power grid are not necessary. In an embodiment, the AC-DC converter may be housed in the nacelle, however, also other positions, for example in the tower, are conceivable. The DC power output by the AC-DC converter may be directly supplied to the desalination plant via the power interface.

Conventional wind turbines often also comprise further, ancillary components for controlling and/or operating the electrical power generation, which consume AC power. In this case, the offshore wind turbine may further comprise at least one DC-AC converter and/or at least one AC-AC converter for providing AC power to the at least one ancillary component. In this manner, the ancillary components may be operated using electrical power generated by the wind turbine itself. However, the DC-AC converter and/or AC-AC converter provides a lesser maximal power than the AC-DC converter, that is, it can be designed way smaller, in particular compared to DC-AC converters for feeding electrical power into a power grid.

In this context, the wind turbine may further comprise an uninterruptable power supply for at least partially supplying AC power to the at least one ancillary component when electrical power from the generator is not available. In some cases, for example when not enough wind is available, the offshore wind turbine will change its operating mode into a sleep mode, where no electrical power is generated. If an uninterruptable power supply (UPS) is provided, this sleep mode may be controllably upheld for a maximum time defined by the storage capacity of the uninterruptable power supply, for example, when a 150 kWh UPS is used, for three days. It is noted that,, the desalination plant is not supplied by the uninterruptable power supply and, instead, comprises the pressure reservoir for bridging phases in which the wind turbine does not produce electrical power.

In embodiments, multiple, in particular containerized, desalination plants may be provided using multiple installation positions. Hence, the offshore wind turbine may comprise multiple, containerized, desalination plants at different installation positions, each equipped with interfaces and a respective support. If the desalination plants are provided in standardized shipping containers, such containers may also be stacked to provide additional installation positions in a space-saving way. Independent from the fact how many desalination plants are used, generally, the electrical consumption is designed to match the electrical power provided by the wind turbine.

In an embodiment, the installation position may be provided on a platform mounted to the tower and/or the foundation of the wind turbine, the platform being positioned above sea level. The installation support may then, for example, be part of the surface of the platform. Such platforms have already been proposed for offshore wind turbines to facilitate access to the tower and/or support components which can or should not be placed in the tower, the foundation and/or the nacelle. Such platforms, in particular in a modified and/or extended manner, may also be used to provide installation positions for the at least one desalination plant. Some of the interfaces may be fixedly installed in or on the platform.

According to embodiments of the invention, multiple offshore wind turbines according to embodiments of the invention may also be combined to form a wind farm according to embodiments of the invention. Here,, freshwater produced by desalination plants of the multiple, particular all, offshore wind turbines may be collected into a common pipe leading to the freshwater receiving site. All features and remarks regarding the offshore wind turbine analogously apply to the wind farm according to embodiments of the invention.

In embodiments of the wind farm, a staged or groupwise collection of freshwater from the offshore wind turbines may be implemented. For example, freshwater produced by groups of the wind turbine may first be joined into a group pipe, wherein the group pipes lead into the common pipe.

While the freshwater receiving site is an onshore facility, where the water may be stored and/or further distributed and/or processed, the freshwater receiving site may also be at sea, for example comprising a floating tank for collecting the freshwater.

An embodiment of the invention also concerns a method for producing freshwater for an onshore, freshwater receiving site. In embodiments,, an offshore wind turbine according to embodiments of the invention or a wind farm according to embodiments of the invention are used. The embodiments include:
generating electrical power using an offshore wind turbine installed at an offshore installation site,
using the electrical power generated by the wind turbine to operate a desalination plant at the installation site, wherein the desalination plant produces freshwater from seawater taken in at the installation site,
transporting the freshwater to the freshwater receiving site using a freshwater piping infrastructure.

All comments and remarks relating to the offshore wind turbine according to embodiments of the invention and the wind farm according to embodiments of the invention also apply to the method according to embodiments of the invention. In embodiments, renewable energy from wind may be used offshore to operate a desalination plant, in particular a reverse osmosis plant, which may directly use seawater from the offshore installation site to produce freshwater, which is transported to the, in particular onshore, receiving site.

### BRIEF DESCRIPTION

Some of the embodiments will be described in detail, with references to the following Figures, wherein like designations denote like members, wherein:

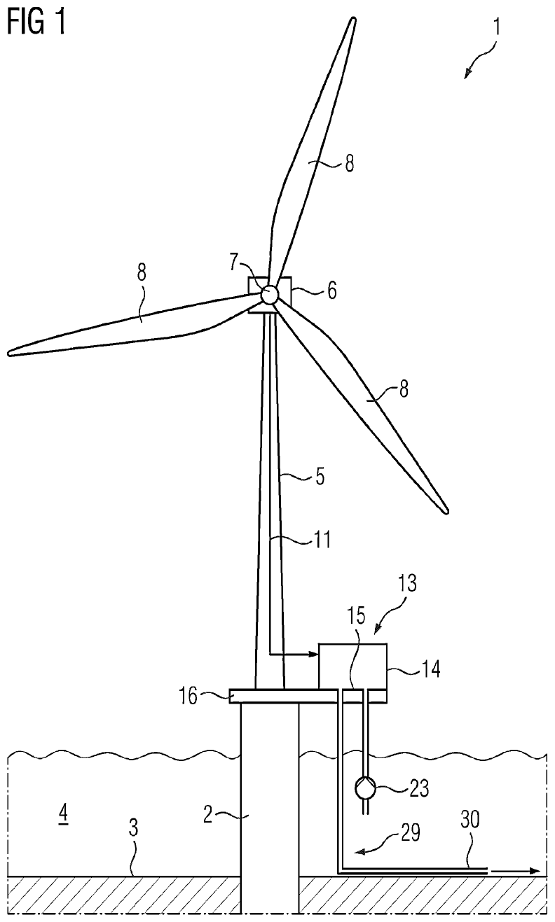

FIG. 1 shows an embodiment of an offshore wind turbine according to embodiments of the invention;

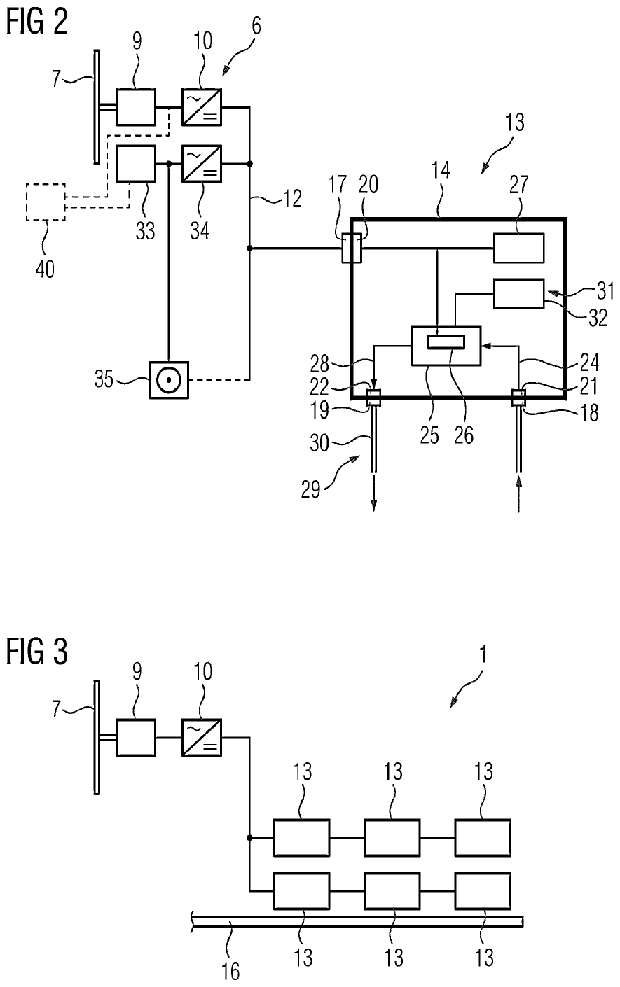

FIG. 2 shows a functional drawing showing further components of the offshore wind turbine of FIG. 1;

FIG. 3 shows schematically a second embodiment of an offshore wind turbine according to embodiments of the invention and

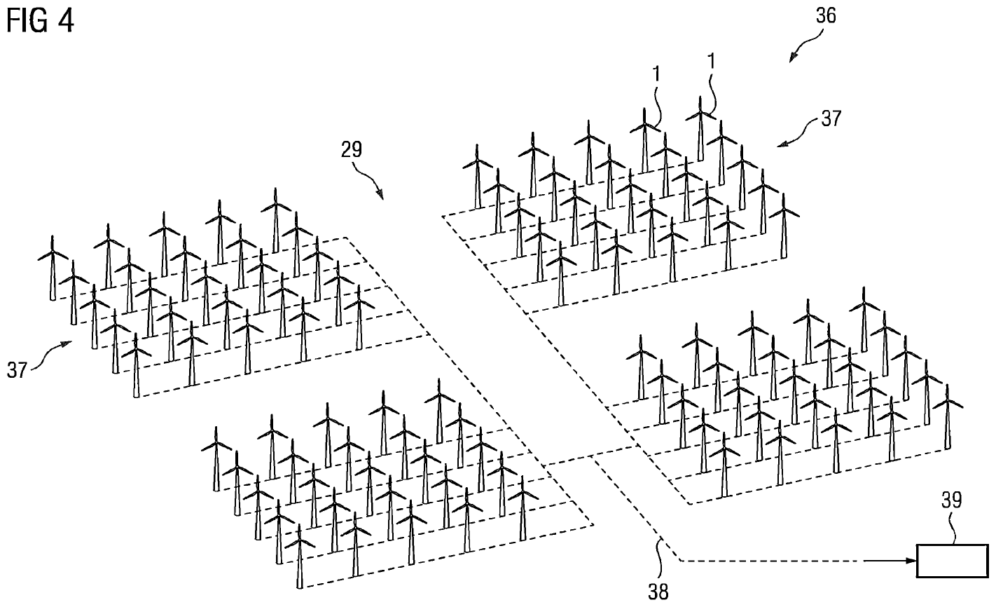

FIG. 4 shows a wind farm according to embodiments of the invention.

### DETAILED DESCRIPTION

FIG. 1 and FIG. 2 illustrate a first embodiment of an offshore off-grid wind turbine 1 according to embodiments of the invention. The wind turbine 1 is built on a foundation 2, which, in this case, is a base mounted to the floor 3 of the sea 4 (that is, the sea bed). The wind turbine 1 further comprises a tower 5 carrying a nacelle 6. The rotor 7 comprises, in this case, three wind turbine blades 8 and is coupled to a generator 9 (see FIG. 2) mounted in the nacelle 6 and supported by a rotor hub (not shown). The generator 9 transforms rotational mechanical power from the rotor 7 into electrical power (AC power), that is, wind energy as renewable energy into electrical energy. Via an AC-DC converter 10 the AC power output by the generator 9 is transformed into DC power. Of course, more than one AC-DC converter 10 may be used.

The electrical power from the generator 9 is, according to arrow 11 in FIG. 1 and power lines 12 in FIG. 2, used to operate a containerized desalination plant 13, in this case a reverse osmosis plant which is protected against the environmental conditions by a container 14, which is or at least has the dimensions of a standardized shipping container. The desalination plant 13 is installed at an installation position 15 of a platform 16, which, in this case, is mounted to the tower 5 and the foundation 2. A part of the surface of the platform 16 forms an installation support for the desalination plant 13 and may, for example, also comprise fastening means for the container 14.

As can best be seen from FIG. 2, at the installation position 15, three standardized interfaces 17, 18 and 19 are provided, matching respective interfaces 20, 21, 22 of the desalination plant 13. Via standardized power interfaces 17, 20 for direct current, for example a plug-and-socket-connection, the electrical power from the generator 9, in this case the DC power output of converter 10, is supplied to the desalination plant 13. Seawater interfaces 18, 21 allow the intake of seawater from the sea 4 at the installation site of wind turbine 1, for example using a pump 23 indicated in FIG. 1 and respective pipes. The pump 23 may be below sea level, that is, submergible, and/or be part of the containerized desalination plant 13, in particular also inside container 14. The seawater, according to arrow 24, then runs through a reverse osmosis unit 25, where it is purified by reverse osmosis, as in principle known in the art. As can be seen, the electrical power for a respective reverse osmosis pump 26 is supplied by the generator 9 via a converter 10. The electrical power generated by the wind turbine 1 may, of course, also be used to supply ancillary consumers 27 of the desalination plant, for example control components and the like. Of course, other steps and components to process and condition the water may also be added to the reverse osmosis, like, for example, an UV unit for sterilization and/or a filtering unit.

The freshwater 25 produced in the reverse osmosis unit 25 is, according to arrow 28, supplied to a freshwater piping infrastructure 29, in this case comprising at least one freshwater pipe 30, via freshwater interfaces 22, 19.

The electrical power generation of the wind turbine 1 is highly dependent on wind conditions. Hence, there may be phases in which electrical power may not be provided by the generator 9 since not enough mechanical power is introduced by rotor 7. To be able to bridge these phases and continuously produce freshwater, the desalination plant 13 further comprises a pressure reservoir 31 comprising a high-pressure storage tank 32. If the reverse osmosis pump 26 cannot be operated, pressure for overcoming the osmotic pressure in the reverse osmosis unit 25 is supplied from the pressure reservoir 31. Of course, the pressure reservoir 31 may be re-filled also using electrical power generated in the wind turbine 1. As a medium for storing pressure, for example, optionally filtered ambient air may be used.

When no electrical power can be generated by the generator 9, the wind turbine 1 begins a so-called sleep mode, wherein some ancillary components 33 of the wind turbine continue minimal operation to monitor the wind turbine 1 and be able to change back to power generation mode. These components are operated using alternating current, that is, AC power. To provide this ancillary AC power, a DC-AC converter 34 is used, as shown in FIG. 2. Alternatively or additionally, an AC-AC converter 40, as indicated with dashed lines in FIG. 2, may also be used. However, since AC power is also required in sleep mode, an uninterruptable power supply 35 (UPS) is provided in the wind turbine 1, for example at the foot of the tower 5. Recharging an electrical energy storage of the UPS 35 may, as indicated by the dashed line in FIG. 2, also be effected directly from the DC power. In the case shown, the UPS 35 may store 150 kWh.

Generally speaking, the (at least one) desalination plant 13 is, regarding its power consumption, designed to match the power generation abilities of the wind turbine 1.

As shown in the schematical view of an alternative, second embodiment of a wind turbine 1 according to embodiments of the invention, the wind turbine 1 may also comprise multiple desalination plants 13 arranged at multiple installation positions 15 on the—in this case larger—platform 16. Since the desalination plants 13 are containerized, at least some installation positions 15 rely on stacking containers 14, such that one desalination plant 13 is supported on another desalination plant 13, which may, in turn, be supported by the platform 16. Of course, interfaces 17, 18 and 19 are provided at all installation positions 15.

When containers are stacked, embodiments are conceivable where one desalination plant 13 comprises multiple containers, which may be stacked, wherein respective interfaces can be provided at the adjacent upper and lower sides of the containers. For example, while one container contains reverse osmosis equipment, another container may contain further processing equipment, e.g., for UV treatment and/or filtering. If the further processing equipment container is the uppermost container, it can simply be exchanged/removed, for example for cleaning and/or maintenance.

Finally, FIG. 4 shows a wind farm 36 according to embodiments of the invention. In this case, the wind farm 36 is divided into multiple groups 37 of off-grid offshore wind turbines 1 according to embodiments of the invention, wherein, as indicated by the dashed lines, freshwater produced by each of the wind turbines 1 is collected in a freshwater piping infrastructure 29 such that it can be transported via a common pipe 38 to a freshwater receiving site 39, which may be onshore, but may also, for example, comprise a floating tank or the like.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-13. (canceled)

14. An offshore wind turbine, comprising a foundation carrying a tower, the tower carrying a nacelle, wherein a generator for generating electrical power is housed in the nacelle, and a rotor including wind turbine blades, which is mounted to a rotor hub and coupled to the generator for providing mechanical input power to the generator,
wherein the wind turbine further comprises at least one desalination plant mounted at an installation position of the wind turbine, the installation position comprising an installation support mechanically supporting the desalination plant,
a power interface for providing electrical power from the generator to the desalination plant, a seawater interface for providing seawater from the installation site of the wind turbine to the desalination plant, and
a freshwater interface for feeding freshwater produced by the desalination plant into a freshwater piping infrastructure for transporting the freshwater to a freshwater receiving site,
wherein the desalination plant is containerized and includes standardized respective interfaces to connect to the interfaces at the installation position.

15. The offshore wind turbine according to claim 14, wherein the desalination plant is a reverse osmosis plant, wherein the electrical power is used at least to drive a reverse osmosis pump of the reverse osmosis plant.

16. The offshore wind turbine according to claim 15, wherein the desalination plant further comprises at least one pressure reservoir for providing pressure when electrical power from the generator is not available.

17. The offshore wind turbine according to claim 16, wherein the pressure reservoir comprises a high pressure storage tank.

18. The offshore wind turbine according to claim 14, wherein the desalination plant comprises outer dimensions of a shipping container.

19. The offshore wind turbine according to claim 14, wherein it further comprises at least one AC-DC converter for converting AC power from the generator into DC power.

20. The offshore wind turbine according to claim 19, wherein the DC power is supplied to the desalination plant via the power interface.

21. The offshore wind turbine according to claim 19, wherein it comprises at least one ancillary, AC power-consuming component for controlling and/or operating the electrical power generation, wherein the offshore wind turbine further comprises at least one DC-AC converter and/or at least one AC-AC converter for providing AC power to the at least one ancillary component.

22. The offshore wind turbine according to claim 21, wherein it further comprises an uninterruptable power supply for at least partially supplying AC power to the at least one ancillary component when electrical power from the generator is not available.

23. The offshore wind turbine according to claim 14, wherein multiple containerized, desalination plants are provided using multiple installation positions.

24. The offshore wind turbine according to claim 14, wherein the installation position is provided on a platform mounted to the tower and/or the foundation of the wind turbine, the platform being positioned above sea level.

25. A wind farm comprising multiple offshore wind turbines according to claim 14 and the freshwater piping infrastructure, wherein freshwater produced by desalination plants of multiple all, offshore wind turbines is collected into a common pipe leading to the freshwater receiving site.

26. A method for producing freshwater for an, onshore, freshwater receiving site using an offshore wind turbine according to claim 14or a wind farm according to claim 25, the method comprising:
generating electrical power using an offshore wind turbine installed at an offshore installation site,
using the electrical power generated by the wind turbine to operate a desalination plant at the installation site, wherein the desalination plant produces freshwater from seawater taken in at the installation site,
transporting the freshwater to the freshwater receiving site using a freshwater piping infrastructure.
